(19) United States
(12) Patent Application Publication
(10) Pub. No.: US 2023/0309201 A1
(43) Pub. Date: Sep. 28, 2023

(54) COOKTOP DEVICE

(71) Applicant: BSH Hausgeräte GmbH, Munich (DE)

(72) Inventors: Alejandro del Cueto Belchi, Zaragoza (ES); Alberto Dominguez Vicente, Zaragoza (ES); Jorge Felices Betran, Huesca (Spain) (ES); Manuel Fernandez Martinez, Zaragoza (ES); Jose Miguel Gil Narvion, Zaragoza (ES); Pablo Jesus Hernandez Blasco, Zaragoza (ES); Eduardo Imaz Martinez, Tudela (Navarra) (ES); Paul Muresan, La Cartuja (ES); Jose Manuel Palacios Gasos, Zaragoza (ES); Alberto Perez Bosque, Zaragoza (ES); Diego Puyal Puente, Zaragoza (ES); Javier Serrano Trullen, Zaragoza (ES)

(21) Appl. No.: 18/023,012

(22) PCT Filed: Aug. 2, 2021
(86) PCT No.: PCT/EP2021/071527

§ 371 Date: Feb. 24, 2023

(30) Foreign Application Priority Data
Sep. 2, 2020 (EP) 20382784

(51) Int. Cl. H05B 6/06

(52) U.S. Cl. CPC H05B 6/065

(57) ABSTRACT

A cooktop apparatus includes a first heating frequency unit, a second heating frequency unit, a set of first heating units, a set of second heating units, a set of third heating units, and a switching arrangement configured to electrically allocate the set of first heating units to the first heating frequency unit, to electrically allocate the set of second heating units to the second heating frequency unit, and to electrically allocate the set of third heating units to at least one of the first and second heating frequency units.

The invention relates to a cooktop apparatus, in particular an induction cooktop apparatus, as claimed in the pre-characterizing clause of claim 1, a cooktop having a cooktop apparatus as claimed in claim 14 and a method for operating a cooktop apparatus as claimed in claim 15.

A cooktop apparatus that has two heating frequency units that comprise in each case two inverters is already known from the prior art. The heating frequency units can be allocated in each case to a set of heating units of the cooktop apparatus.

The object of the invention is to provide in particular, but is not limited to, an apparatus of the generic type having improved characteristics with regard to a degree of flexibility. The object is achieved in accordance with the invention by the features of claim 1 while advantageous embodiments and developments of the invention can be taken from the subordinate claims.

The invention is based on a cooktop apparatus, in particular an induction cooktop apparatus, having at least one first heating frequency unit, having at least one second heating frequency unit, having a switching arrangement, and having at least one set of first heating units that can be electrically allocated by means of the switching arrangement to the first heating frequency unit, and having at least one set of second heating units that can be electrically allocated by means of the switching arrangement to the second heating frequency unit.

It is proposed that the cooktop apparatus has at least one set of third heating units that can be electrically allocated by means of the switching arrangement to at least one of the heating frequency units.

It is possible by means of an embodiment of this type to provide in particular a cooktop apparatus that has improved characteristics with regard to a degree of flexibility and namely in particular with regard to possible cookware configurations. In particular, a number of heating zones that can be operated simultaneously using different heating power can be increased. Moreover, as a consequence, further cookware configurations can be rendered possible in which in particular an increased number of items of cookware is heated in each case using different heating power. As a consequence, moreover and namely in particular owing to the increased flexibility, it is possible to increase convenience, in particular user convenience. In particular, it is possible by means of a single cooking appliance apparatus to operate an increased flexibility, in particular with regard to a combination of larger and smaller items of cookware. In particular, the user can distribute items of cookware on a cooktop plate in a more flexible manner. Moreover, by means of an embodiment of this type it is possible in particular to achieve an increased flexibility with regard to a distribution of a load to the inverters of the cooktop apparatus. In particular, a load of the inverters of the cooktop apparatus can be distributed uniformly to the inverters of the cooktop apparatus. As a consequence, it is moreover possible to reduce wear and in particular it is possible to increase a service life of the cooktop apparatus. As a consequence, it is possible in particular to increase user satisfaction. In particular, a high degree of flexibility can be rendered possible with regard to a multiplexing operation. In particular, as a consequence it is possible to omit additional inverters whereby in particular it is possible to provide a cooktop apparatus having particularly advantageous characteristics with regard to cost efficiency. In particular, a possible number of heating zones that are operated using independent heating powers can be increased, said number rendering it possible to omit a multiplexing operation. In particular, it is possible by means of an embodiment of this type moreover to achieve an improved flexibility with regard to possible parallel operation of inverters. In particular, the number of heating zones that can be operated using independent heating powers, said number rendering it possible to omit a multiplexing operation, can be increased in such a manner that the number is higher than a number of inverters that the cooktop apparatus has in each case. For example, it is possible by means of an embodiment of this type having four inverters to provide a number of heating zones that is greater than four, said heating zones being operated using independent heating powers. Moreover, it is possible to achieve improved characteristics with regard to an efficiency and namely in particular in relation to heating units that are only in part covered by cookware. In particular, it is possible to achieve that the heating units that are only in part covered by cookware can be operated using a correspondingly adapted heating power, which in particular renders possible an advantageous heating power distribution. In particular, in relation to the set of third heating units it is possible to further increase a degree of flexibility since the set of third heating units can be allocated to any heating frequency units. In particular, it can be rendered possible to allocate unused inverters to flexibly operated heating units. For example, inverters that in the operating state do not operate any heating units of the set of first heating units and/or the set of second heating units can be allocated to the set of third heating units in the event of this set being operated in the operating state. Consequently, it is possible by means of an embodiment of this type moreover to achieve improved characteristics with regard to a heating power, in particular with regard to a boost mode. In particular, by means of an embodiment of this type it is possible to increase a number of heating zones that can be operated in a boost mode. The user friendliness can thereby be further increased. The flexibility, and thereby in particular the user friendliness, can moreover be further increased in that it is possible to omit a printing of a cooktop plate so as to point the user to possible heating zones or the like. Moreover, it is possible as a consequence to further increase cost efficiency. Advantageously, a cooking experience of the user improves due to the flexibility that is consequently obtained. In particular, moreover, improved characteristics with regard to a modularity can be achieved since the embodiment of this type can use a plurality of conceivable cooktop topologies.

A “cooktop apparatus”, in particular an “induction cooktop apparatus”, is to be understood to mean at least a part, in particular a subassembly, of a cooktop, in particular of an induction cooktop, wherein in particular in addition accessory units for the cooktop can also be comprised such as for example a sensor unit for the external measurement of a temperature of an item of cookware and/or of food. In particular, the cooktop apparatus, in particular the induction cooktop apparatus, can also comprise the entire cooktop, in particular the entire induction cooktop.

A heating frequency unit comprises in particular at least one inverter, preferably at least two inverters, which preferably has at least two bidirectional unipolar switches, preferably connected in series, which are formed in particular by a transistor and a diode connected in parallel, and particularly advantageously at least in each case a damping capacity that is connected in parallel to the bidirectional unipolar switches and that is formed in particular by at least one capacitor.

An “inverter” is to be understood to mean a unit that in at least one operating state provides an, in particular high-frequency, alternating current, in particular at a frequency of at least 10 kHz, preferably of at least 20 kHz and in particular of at most 100 kHz, for at least one further unit, in particular for at least one heating unit and/or for at least one intermediate heating unit of the cooktop apparatus. In particular, the inverter can comprise inverter switching elements that can be designed in particular as IGBT, MOSFET, HEMT, JFET and/or as TRIAC. In particular, the inverter switching elements can be formed at least in part from a semiconductor material, such as for example silicon, silicon carbide and/or gallium nitride and/or from another semiconductor material that appears expedient to a person skilled in the art.

A “switching arrangement” is to be understood to mean an electrical unit that has in particular at least one switching element and advantageously a plurality of switching elements. In particular, the switching arrangement is provided so as to allocate a set of heating units, for example the set of first heating units and/or the set of second heating units and/or the set of third heating units, to one of the heating frequency units, for example to the first heating frequency unit and/or to the second heating frequency unit, advantageously to at least one inverter of one of the heating frequency units.

A “switching element” is to be understood to mean an electronic or electrical element that is provided so as to produce and/or to disconnect an electrically conductive connection between two points, in particular contacts of the switching element. The switching element preferably has at least one control contact via which the switching element can be switched. In particular, the switching element is designed as a semiconductor switching element, in particular as a transistor, advantageously as a bipolar transistor having preferably an insulated gate electrode (IGBT). Alternatively, the switching element is designed as a mechanical and/or electromechanical switching element, in particular as a relay. In particular, the set of first heating units has at least two first heating units that are designed in particular as induction heating units. Preferably the set of first heating units is a group of first heating units that comprises for example at least three first heating units and preferably at least four first heating units that are designed in particular as induction heating units. However, another expedient number of first heating units of the set of first heating units would also be conceivable.

In particular, the set of second heating units has at least two second heating units that are designed in particular as induction heating units. Preferably the set of second heating units is a group of second heating units that comprises for example at least three second heating units and preferably at least four second heating units that are designed in particular as induction heating units. However, another expedient number of second heating units of the set of second heating units would also be conceivable.

In particular, the set of third heating units has at least one third heating unit that is designed in particular as an induction heating unit. Preferably the set of third heating units is a group of third heating units that preferably has at least two third heating units, wherein another number of third heating units would also be conceivable.

A “heating unit” is to be understood to mean a consumer unit having at least one heating element. For example, the heating element could be a consumer that is provided so as to convert electrical energy into heat. Preferably the heating unit comprises at least one heating element that is designed as an inductor. An “inductor” is to be understood here to mean an element that has at least one induction coil and/or is designed as an induction coil and that is provided so as to provide, in at least one operating state, at least one receiving element with energy, in particular in the form of an alternating magnetic field. The receiving element is designed in particular as a part and/or a subassembly of a receiving unit and is provided in particular so as to receive the energy that is provided by at least one inductor. The receiving unit can be in particular part of the cooktop apparatus. Alternatively, it is conceivable that the receiving unit is designed as a unit that is independent of the household appliance apparatus and/or as part of a further apparatus that is independent of the cooktop apparatus. The receiving unit can be provided in particular for placement on a region above the inductor. The receiving unit could be designed for example as an item of cookware and could have in particular at least one secondary coil as a receiving element so as to receive the energy that is provided by the inductor and/or the further inductor. Alternatively or in addition, the receiving element could also be designed as a metal heating means, in particular as an at least in part ferromagnetic heating means, for example as a ferromagnetic base of an item of cookware, in which in an operating state of the heating unit eddy currents and/or demagnetization effects are induced by the inductor and the eddy currents and/or demagnetization effects are converted into heat.

For example, the first heating units of the set of first heating units can differ from the second heating units of the set of second heating units with regard to a power consumption that is provided and/or a power output that is provided and/or with regard to their geometry and/or their size. Preferably the first heating units of the set of first heating units are designed as at least essentially identical to the second heating units of the set of second heating units. Moreover, it would be conceivable that the third heating units of the set of third heating units differ from the first heating units of the set of first heating units and/or the second heating units of the set of second heating units at least with respect to a geometry and/or with respect to an orientation.

For example, the cooktop apparatus could have a control unit that controls the switching arrangement as a function of a cookware configuration and/or as a function of an operating mode that is set by a user. In particular, the control unit produces operating states, in particular by controlling the switching arrangement. A “control unit” is to be understood to mean an electronic unit that is preferably at least in part integrated into an open-loop control and/or closed-loop control unit of the cooktop and that is preferably provided so as to open-loop control and/or to closed-loop control in particular at least the heating frequency units and/or the inverters of the heating frequency units and/or the switching arrangement. Preferably the control unit comprises a computing unit and in particular in addition to the computing unit a storage unit having an open-loop control program and/or a closed-loop control program that is stored therein and that is provided so as to be executed by the computing unit. A “cookware configuration” is a number and/or a position and/or composition of cookware that is placed, in particular cookware that is placed on the cooktop. In particular, a plurality of possible cookware configurations is conceivable. For example, the cookware configuration is a combination of number and/or position and/or composition of cookware that is placed. In particular, the control unit controls the switching arrangement as a function of the cookware configuration so that an allocation of the sets of heating units to the heating frequency units, in particular to the inverters of the heating frequency units, corresponds at least essentially to the cookware configuration. This means that the control unit is provided in particular so as to control the switching arrangement as a function of the cookware configuration in such a manner that cookware that is placed can be operated as individually as possible and can be heated at least essentially over the entire surface and with the heating power that is desired by the user and namely in particular in one operating state.

An “operating state” is a state of the cooktop apparatus in which at least one set of heating units, for example the set of first heating units and/or the set of second heating units and/or the set of third heating units, advantageously at least one heating unit of one of the sets of heating units, is operated in particular so as to heat the cookware. In particular, a plurality of operating states is possible which differ in particular with regard to the allocation of sets of heating units, in particular of at least one heating unit of at least one set of heating units, to heating frequency units, in particular to at least one inverter of at least one heating frequency unit. In particular, in one operating state at least the set of heating units that is operated, in particular at least one heating unit of the set of heating units that is operated is allocated to a heating frequency unit, in particular to at least one inverter of a heating frequency unit.

In particular, the set of third heating units can be electrically allocated by means of the switching arrangement to at least any one heating frequency unit of the heating frequency units. The fact that a set of heating units “can be electrically allocated” to a heating frequency unit is to be understood to mean that the set of heating units and namely in particular at least one heating unit of the set of heating units can be electrically connected by means of the switching arrangement to the heating frequency unit and namely in particular to at least one inverter of the heating frequency unit, in particular in order to achieve an operating state.

The fact that a set of heating units is “allocated” to a heating frequency unit is to be understood in particular to mean that the set of heating units, in particular at least one heating unit of the set of heating units, is electrically connected by means of the switching arrangement to the heating frequency unit and namely in particular to at least one inverter of the heating frequency unit, in particular in the operating state. In particular, this is accordingly also to be understood in an allocation in the opposite direction.

“Provided” is to be understood to mean specifically programmed, designed and/or equipped. The fact that an object is provided for a specific function is to be understood to mean that the object fulfills and/or executes this specific function in at least one application state and/or operating state.

Moreover, it is proposed that the set of third heating units can be electrically allocated by means of the switching arrangement to the first heating frequency unit and to the second heating frequency unit. By means of an embodiment of this type, it is possible to improve in particular a degree of flexibility. This means that, in particular in one conceivable operating state, the set of third heating units is electrically allocated by means of the switching arrangement to the first heating frequency unit and to the second heating frequency unit. For example, at least one third heating unit of the set of third heating units can be electrically allocated by means of the switching arrangement to at least one inverter of the first heating frequency unit and to at least one inverter of the second heating frequency unit. Moreover, it would be conceivable that multiple third heating units of the set of third heating units can be electrically allocated by means of the switching arrangement to multiple inverters of the first heating frequency unit and to multiple inverters of the second heating frequency unit. In particular, in one operating state at least one third heating unit of the set of third heating units is electrically allocated by means of the switching arrangement to at least one inverter of the first heating frequency unit and to at least one inverter of the second heating frequency unit.

Moreover, it is proposed that the set of third heating units can be allocated by means of the switching arrangement to at least two inverters of one of the heating frequency units, for example of the first heating frequency unit and/or of the second heating frequency unit. As a consequence, it is possible to improve in particular improved characteristics with regard to a heating power. In particular, it can be rendered possible that the set of third heating units can be operated in a boost mode. This means that the set of third heating units in one operating state is allocated by means of the switching arrangement to at least two inverters of one of the heating frequency units, for example of the first heating frequency unit and/or of the second heating frequency unit. In particular, the set of third heating units can be allocated by means of the switching arrangement simultaneously to at least two inverters of one of the heating frequency units, for example of the first heating frequency unit and/or of the second heating frequency unit. In particular, at least one third heating unit of the set of third heating units and preferably multiple third heating units of the set of third heating units can be allocated by means of the switching arrangement simultaneously to at least two inverters of one of the heating frequency units, for example of the first heating frequency unit and/or of the second heating frequency unit. Preferably all the third heating units of the set of heating units can be allocated by means of the switching arrangement simultaneously to all the inverters of one of the heating frequency units, for example of the first heating frequency unit and/or of the second heating frequency unit.

Furthermore, it is proposed that the set of third heating units can be allocated by means of the switching arrangement to at least two of the heating frequency units. As a consequence, it is possible to further improve a degree of flexibility. In particular, at least one third heating unit of the set of third heating units can be allocated by means of the switching arrangement simultaneously to two of the heating frequency units, in particular simultaneously to the first heating frequency unit and to the second heating frequency unit. Preferably all the third heating units of the set of third heating units can be allocated by means of the switching arrangement simultaneously to two of the heating frequency units, in particular simultaneously to the first heating frequency unit and to the second heating frequency unit.

Moreover, it is proposed that the set of third heating units comprises at least two third heating units that can be allocated by means of the switching arrangement simultaneously to different heating frequency units. As a consequence, it is possible to achieve in particular a high degree of flexibility. Preferably all the third heating units of the set of third heating units can be allocated by means of the switching arrangement simultaneously to different heating frequency units. In particular, in one operating state the at least two third heating units of the set of third heating units are allocated by means of the switching arrangement simultaneously to different heating frequency units.

Moreover, it is proposed that the set of third heating units can be allocated by means of the switching arrangement with the set of first heating units and/or with the set of second heating units to a common inverter of one of the heating frequency units. It is possible by means of an embodiment of this type to provide in particular a particularly high degree of flexibility and namely in particular with regard to possible heating zones. Moreover, it is possible by means of an embodiment of this type to achieve that large items of cookware can also be operated by a dedicated heating zone. In particular, the set of third heating units can be allocated by means of the switching arrangement together with the set of first heating units to a common inverter of one of the heating frequency units. Alternatively or in addition, the set of third heating units can be allocated together with the set of second heating units by means of the switching arrangement to a common inverter of one of the heating frequency units. In particular, in one conceivable operating state the set of third heating units is allocated by means of the switching arrangement with the set of first heating units to a common inverter of one of the heating frequency units. In particular, in a further conceivable operating state the set of third heating units is allocated by means of the switching arrangement with the set of second heating units to a common inverter of one of the heating frequency units. In particular, the set of third heating units can be operated together with the set of first heating units as a heating zone. Alternatively or in addition, the set of third heating units can be operated together with the set of second heating units as a heating zone. A “heating zone” is to be understood to mean a region, in particular a volume, preferably a surface that is provided so as to receive at least one object that is to be heated, in particular at least one item of cookware and/or at least one item of food. In particular, in one operating state in which a heating zone of the set of third heating units is operated together with the set of first heating units and/or of the set of third heating units is operated together with the set of second heating units at least 50%, in particular at least 70%, advantageously at least 80%, preferably at least 90%, of a common heating power of the set of third heating units and of the set of first heating units and/or of the set of third heating units and of the set of second heating units is output into the heating zone. In particular, it is possible to operate different heating zones in each case with a dedicated heating power.

Furthermore, it is proposed that the set of third heating units can be allocated by means of the switching arrangement with the set of first heating units to a common inverter of one of the heating frequency units and simultaneously by means of the switching arrangement with the set of second heating units to a common inverter of one of the heating frequency units. It is possible by means of an embodiment of this type to further increase a degree of flexibility. It is possible, in particular in one operating state, to operate a high number of heating zones. In particular, it is consequently possible to achieve that a plurality of large items of cookware can be operated by a dedicated heating zone and namely in particular in one operating state. This means that the set of third heating units in one operating state is allocated by means of the switching arrangement with the set of first heating units to a common inverter of one of the heating frequency units and simultaneously by means of the switching arrangement with the set of second heating units to a common inverter of one of the heating frequency units. In particular, the set of third heating units can be allocated by means of the switching arrangement with the set of first heating units to a common inverter of one of the heating frequency units and simultaneously by means of the switching arrangement with the set of second heating units to a common further inverter of a further one of the heating frequency units. In particular, the set of third heating units can be operated together with the set of first heating units as a heating zone and simultaneously together with the set of second heating units as a further heating zone. For example, at least a part of the third heating units of the set of third heating units could be allocated by means of the switching arrangement with at least a part of first heating units of the set of first heating units to the first heating frequency unit, in particular to an inverter of the first heating frequency unit, and simultaneously at least a further part of the third heating units of the set of third heating units can be allocated by means of the switching arrangement with at least a part of second heating units of the set of second heating units to a further inverter of one of the heating frequency units.

Moreover, it is proposed that the switching arrangement has at least one parallel switching unit by means of which at least two inverters of a heating frequency unit, in particular at least two inverters of the first heating frequency unit and/or at least two inverters of the second heating frequency unit, can be connected in parallel, wherein the set of first heating units and/or the set of second heating units has a plurality of heating units that can be allocated by means of the switching arrangement simultaneously to multiple inverters of a heating frequency unit. As a consequence, it is possible to achieve in particular a particularly high heating power. Since as a consequence it is possible in particular to provide a particularly high heating power to the user, it is moreover consequently possible to increase in particular user satisfaction. Moreover, as a consequence it is possible to achieve in particular a higher degree of flexibility, in particular with regard to possible allocations of heating frequency units to sets of heating units and in particular of inverters to heating units. In particular, the set of first heating units has a plurality of, for example at least two, advantageously at least three and preferably at least four first heating units and the set of second heating units has a plurality of, for example at least two, advantageously at least three and preferably at least four second heating units that can be allocated by means of the switching arrangement in each case simultaneously to the parallel-connected inverters of a heating frequency unit. In particular, by means of the parallel switching unit at least two inverters of the first heating frequency unit and/or at least two inverters of the second heating frequency unit can be connected in parallel. The fact that by means of the parallel switching unit of the switching arrangement at least two inverters of a heating frequency unit can be connected in parallel means that by means of the parallel switching unit in one conceivable operating state at least two inverters of a heating frequency unit are connected in parallel. A “parallel switching unit” is to be understood to mean an electrical unit that is provided so as to connect, in at least one operating state, at least two inverters of a heating frequency unit in parallel, and namely in particular by means of parallel switching elements and/or switch positions of the parallel switching elements that are suitable for this purpose. In particular, the at least two inverters, in at least the operating state in which the at least two inverters are connected in parallel by means of the parallel switching unit of the switching arrangement, can supply the plurality of heating units, in particular the set of first heating units and/or the set of second heating units, simultaneously with alternating current. Moreover, it would be conceivable that by means of the parallel switching unit of the switching arrangement for example at least three inverters of a heating frequency unit can be connected in parallel, in particular at least three inverters of the first heating frequency unit and/or at least three inverters of the second heating frequency unit. Moreover, it would be conceivable that by means of the parallel switching unit of the switching arrangement for example at least four inverters of a heating frequency unit can be connected in parallel, in particular at least four inverters of the first heating frequency unit and/or at least four inverters of the second heating frequency unit. Likewise, for example it would be conceivable that by means of the parallel switching unit of the switching arrangement all the inverters of a heating frequency unit can be connected in parallel, in particular of the first heating frequency unit and/or of the second heating frequency unit.

Moreover, it is proposed that all the sets of heating units can be allocated by means of the switching arrangement to different inverters of the heating frequency units. As a consequence, it is possible to achieve in particular a high degree of flexibility and namely advantageously with regard to possible cookware configurations. It is possible by means of an embodiment of this type in particular to achieve that for each set of heating units an independent heating zone can be provided in which in each case at least one item of cookware can be heated with a dedicated heating power. In particular, all the sets of heating units can be operated by means of the switching arrangement in each case as dedicated heating zones. In particular, an operating state is conceivable in which all the sets of heating units, in particular the set of first heating units, the set of second heating units and the set of third heating units, are allocated to different inverters of the heating frequency units. It would be conceivable that in the operating state in which all the sets of heating units, in particular the set of first heating units, the set of second heating units and the set of third heating units, are allocated to different inverters of the heating frequency units, at least one of the sets of heating units, for example the set of first heating units and/or the set of second heating units and/or the set of third heating units is allocated to multiple inverters.

Furthermore, it is proposed that all the sets of heating units comprise at least two heating units that can be allocated by means of the switching arrangement in each case to different inverters of the heating frequency units and namely in particular to different inverters of the first heating frequency unit or different inverters of the second heating frequency unit. As a consequence, in particular a degree of flexibility can be further increased. In particular, the flexibility can be further increased owing to an increased number of heating zones that can be individually operated. And namely in particular, the at least two heating units that can be allocated by means of the switching arrangement in each case to different inverters of the heating frequency units can be operated in each case as dedicated heating zones. In particular, an operating state is conceivable in which the at least two heating units are allocated by means of the switching arrangement in each case to different inverters of the heating frequency units. For example, the set of first heating units could comprise at least two first heating units, advantageously at least three first heating units and preferably at least four first heating units that can be allocated by means of the switching arrangement in each case to different inverters of the heating frequency units. For example, the set of second heating units alternatively or in addition could comprise at least two second heating units, advantageously at least three second heating units and preferably at least four second heating units that can be allocated by means of the switching arrangement in each case to different inverters of the heating frequency units. For example, the sets of heating units, in particular the set of first heating units and/or the set of second heating units could comprise a different number of at least two heating units that can be allocated by means of the switching arrangement in each case to different inverters of the heating frequency units. Preferably the set of first heating units and the set of second heating units comprise an identical number of at least two heating units that can be allocated by means of the switching arrangement in each case to different inverters of the heating frequency units. In particular, if the set of first heating units and/or the set of second heating units comprises a number of more than two heating units, at least two first heating units and/or at least two second heating units could be allocated by means of the switching arrangement in each case to different inverters of the heating frequency units and at least two first heating units and/or at least two second heating units combined by means of the switching arrangement can be allocated to an inverter of the heating frequency units.

Moreover, it is proposed that the set of first heating units and/or the set of second heating units has at least two outer heating units and at least two inner heating units that are arranged within the outer heating units, wherein the inner heating units and the outer heating units can be allocated by means of the switching arrangement simultaneously to different inverters of one of the heating frequency units. As a consequence, it is possible to improve a degree of flexibility and namely in particular with regard to a differentiated heating power control of the outer and inner heating units. As a consequence, it is in particular possible to achieve that in particular elongated items of cookware such as for example an item of cookware that is designed as a Teppanyaki grill that is placed on a cooktop above the set of first heating units or above the set of second heating units and consequently entirely covers the inner heating units and in each case only in part covers the outer heating units is heated using correspondingly distributed heating power. In particular, it is possible to achieve that the outer heating units and the inner heating units can be operated using different heating power.

Furthermore, it is proposed that the cooktop apparatus has at least one third heating frequency unit and at least one set of fourth heating units that can be electrically allocated by means of the switching arrangement to the third heating frequency unit and that the cooktop apparatus has at least one set of fifth heating units that can be electrically allocated by means of the switching arrangement to at least one of the second heating frequency unit and/or the third heating frequency unit.

It is possible by means of an embodiment of this type to further increase in particular a degree of flexibility. Furthermore, it is possible to further improve convenience, in particular user convenience. In particular, it is possible by means of an embodiment of this type to provide a particularly extensive and flexible cooktop having the cooktop apparatus. Moreover, by means of an embodiment of this type it is possible in particular to provide a cooktop apparatus that has a high number of heating zones.

In particular, the features that are described above for the set of first heating units, the set of second heating units, the set of third heating units, the first heating frequency unit and the second heating frequency unit apply in a similar manner for the set of fourth heating units, the set of fifth heating units and the third heating frequency unit.

Moreover, it is proposed that the set of third heating units is arranged spatially between the set of first heating units and the set of second heating units. In particular, this feature applies in a corresponding manner for the set of fifth heating units that is accordingly arranged spatially between the set of second heating units and the set of fourth heating units. As a consequence, in particular it is possible to achieve a higher degree of flexibility with regard to possible placement positions of cookware. In particular, it is consequently possible to also heat large items of cookware across their whole surface. In particular, it is consequently advantageously possible to provide large heating zones.

The phrase that the set of third heating units is arranged “spatially between the set of first heating units and the set of second heating units” is to be understood to mean that the third heating units of the set of third heating units, in particular when viewed in a plan view of a cooktop, are surrounded at least on two sides by the set of first heating units and the set of second heating units. Advantageously, the third heating units of the set of third heating units are arranged adjoining a plurality of first heating units of the set of first heating units and/or adjoining a plurality of second heating units of the set of second heating units. Advantageously, at least one third heating unit of the set of third heating units is arranged adjoining at least two and preferably at least three first heating units of the set of first heating units. Moreover, at least one further third heating unit of the set of third heating units is arranged adjoining at least two and preferably at least three second heating units of the set of second heating units. “Adjoining” is to be understood in this context to mean that a gap between the third heating units of the set of third heating units and the first heating units of the set of first heating units and/or the second heating units of the set of second heating units is for example less than 15 cm, advantageously less than 10 cm, particularly advantageously less than 5 cm, preferably less than 3 cm and particularly preferably less than 1 cm.

Furthermore, a cooktop, in particular an induction cooktop, having at least one cooktop apparatus is proposed. It is consequently possible to further increase a degree of flexibility. Moreover, it is possible in particular to increase user satisfaction.

Moreover, the invention relates to a method for operating a cooktop apparatus, in particular an induction cooktop apparatus, having at least one first heating frequency unit and having at least one second heating frequency unit and having at least one set of first heating units, which in at least one operating state are electrically allocated to the first heating frequency unit, and having at least one set of second heating units, which in the at least one operating state are electrically allocated to the second heating frequency unit, and having at least one set of third heating units, which in the at least one operating state are electrically allocated to one of the heating frequency units. It is possible by means of an embodiment of this type to achieve in particular a particularly high degree of flexibility.

The cooktop apparatus, the cooktop and the method for operating the cooktop apparatus are not to be restricted here to the application and embodiment described above. In particular, the cooktop apparatus, the cooktop, and the method for operating the cooktop apparatus in order to fulfill a function that is described herein can have a number of individual elements, components, units, and method steps that deviates from a number that is mentioned herein.

Further advantages are provided in the following description of the figures. Nine exemplary embodiments of the invention are illustrated in the figures. In order to differentiate the exemplary embodiments, the letters a to i are added to the reference characters of the following description of the figures. In relation to components that are designated identically, in particular in reference to components having identical reference characters, reference is generally to be made to the description and/or to the drawings of the first exemplary embodiment having the letter a. The descriptions of the further exemplary embodiments are limited essentially to the differences between the exemplary embodiments. The figures, the description of the figures and the claims include numerous features in combination. The person skilled in the art will also expediently consider the features individually and will combine the features to expedient further combinations.

In the drawings:

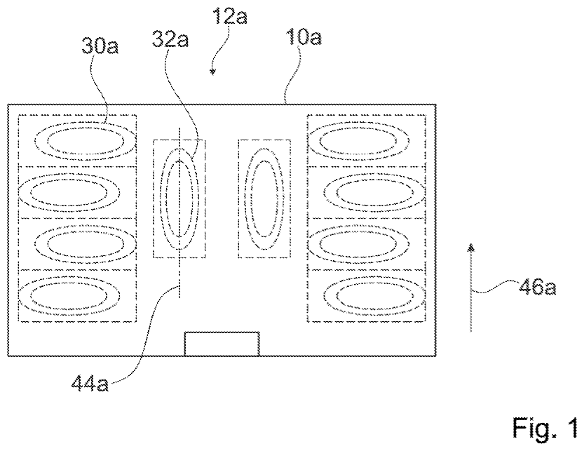

FIG. 1 shows a cooktop, which is designed as an induction cooktop, having a cooktop apparatus in a plan view,

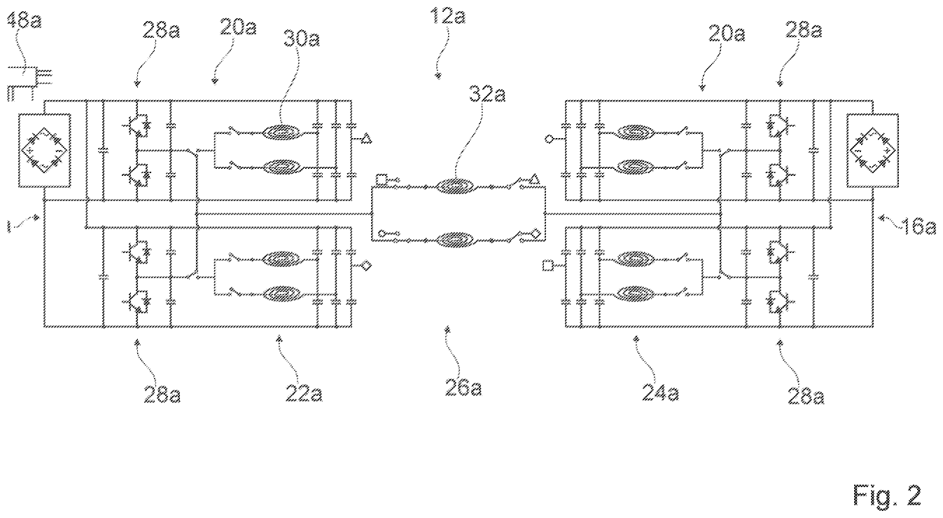

FIG. 2 shows a circuit diagram of the cooktop apparatus having a set of first heating units, having a set of second heating units, having a set of third heating units and having a switching arrangement,

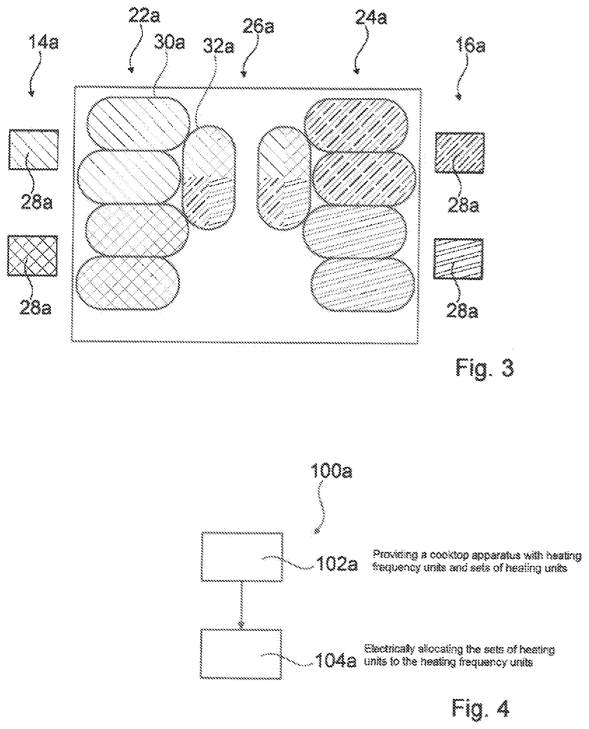

FIG. 3 shows a selection of allocations of heating units, which can be performed by means of the switching arrangement, to inverters of a first heating frequency unit and inverters of a second heating frequency unit of the cooktop apparatus,

FIG. 4 shows a flow diagram of a method for operating the cooktop apparatus,

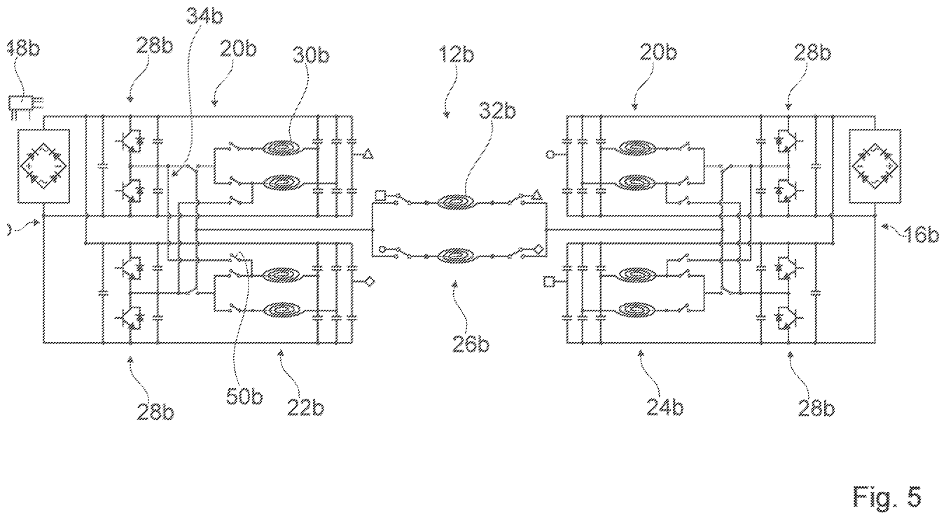

FIG. 5 shows a further cooktop apparatus of a further exemplary embodiment having a switching arrangement in a circuit diagram,

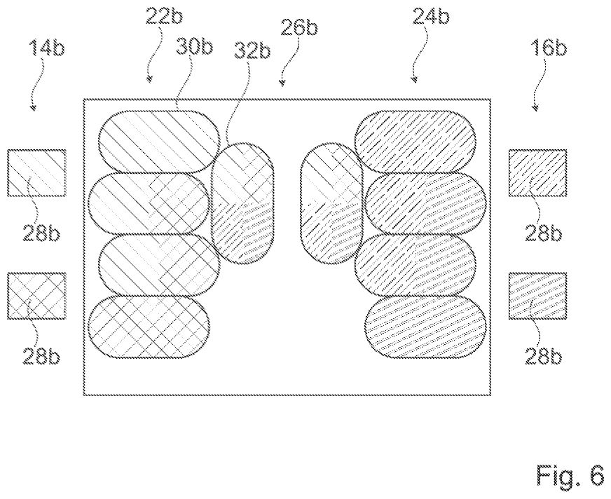

FIG. 6 shows a further selection of allocations that can be performed by means of the switching arrangement,

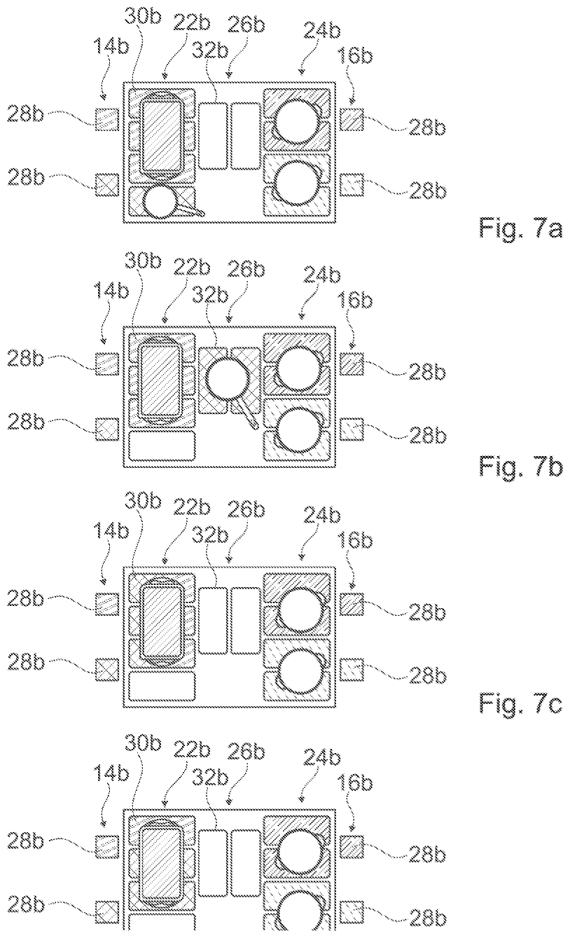

FIG. 7 shows a selection of possible operating states of the cooktop apparatus,

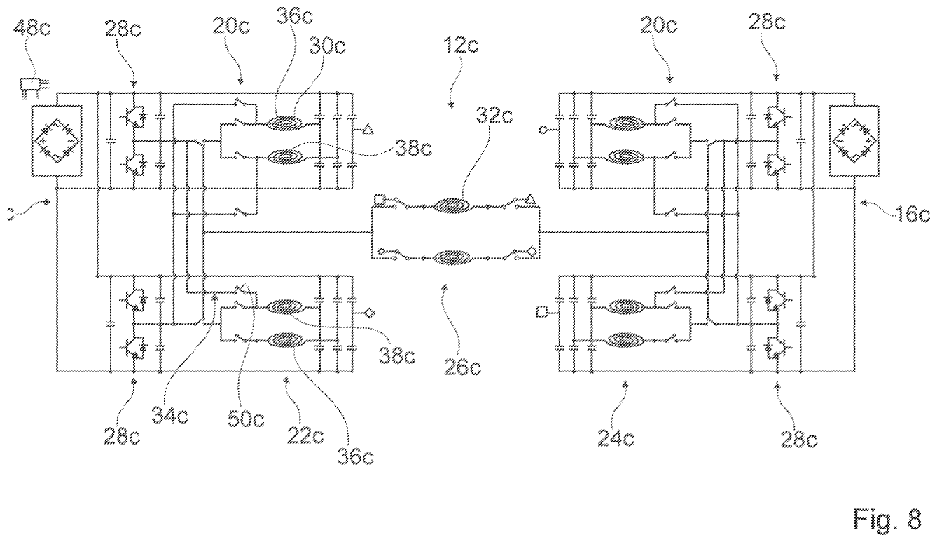

FIG. 8 shows a further cooktop apparatus of a further exemplary embodiment having a switching arrangement in a circuit diagram,

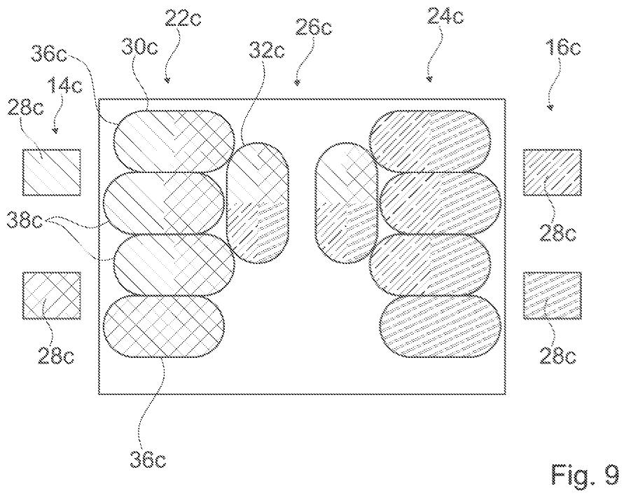

FIG. 9 shows a further selection of allocations that can be performed by means of the switching arrangement,

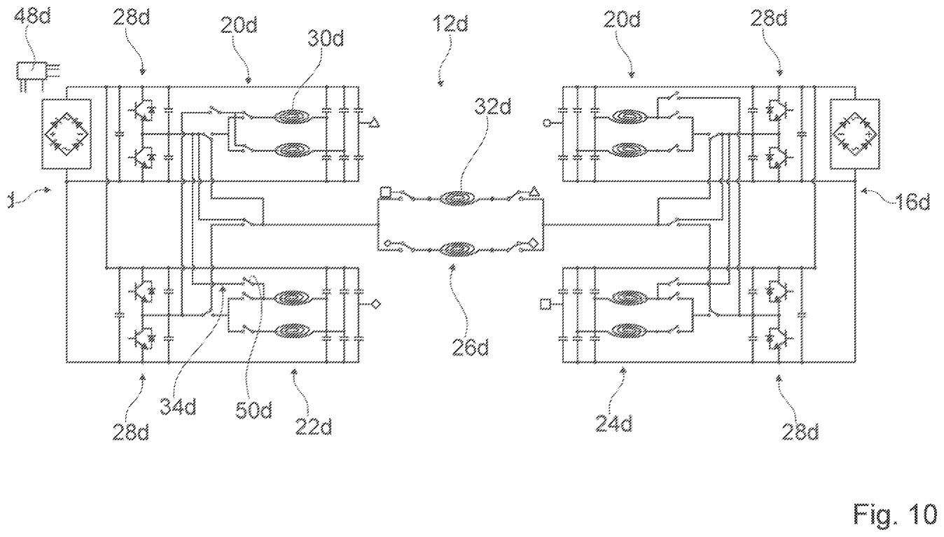

FIG. 10 shows a further cooktop apparatus of a further exemplary embodiment having a switching arrangement in a circuit diagram,

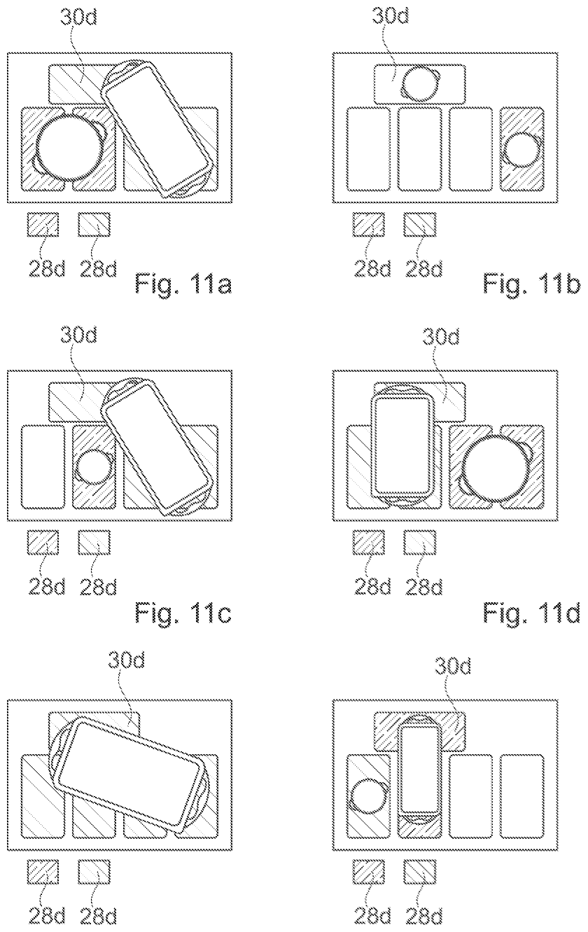

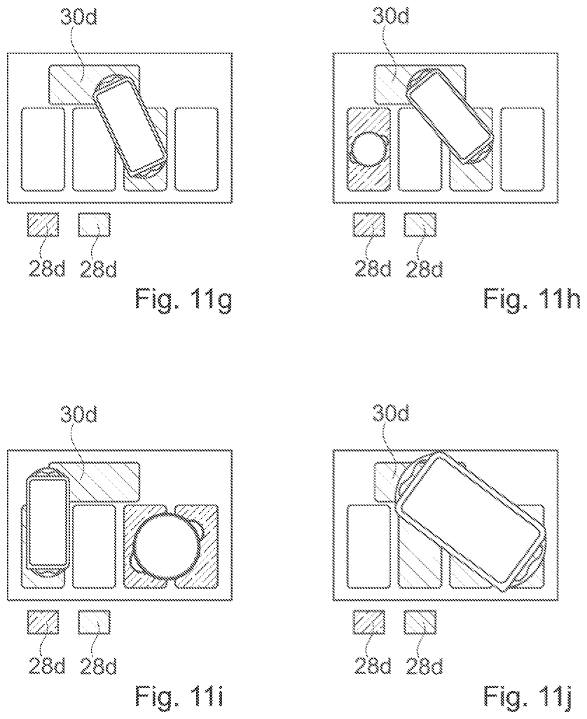

FIG. 11 shows a further selection of possible operating states of the cooktop apparatus in a simplified illustration,

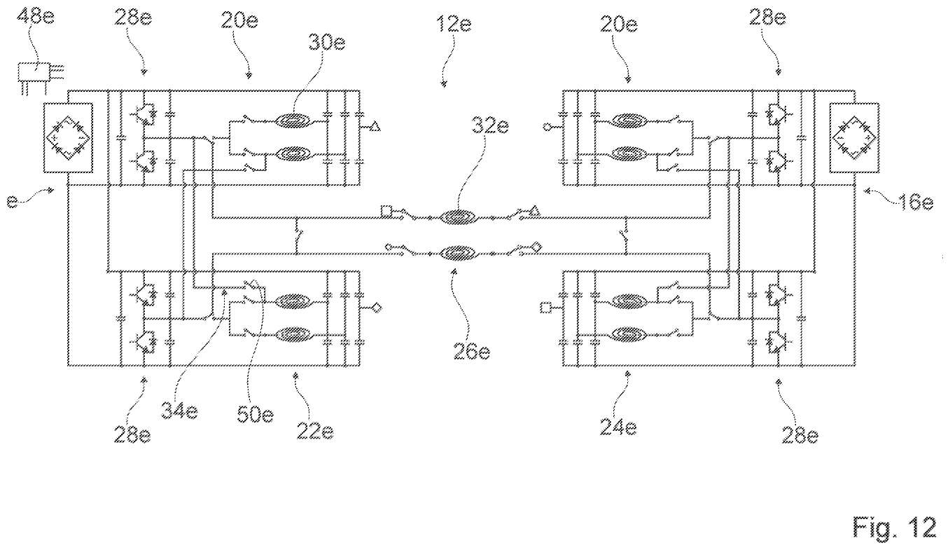

FIG. 12 shows a further cooktop apparatus of a further exemplary embodiment having a switching arrangement in a circuit diagram,

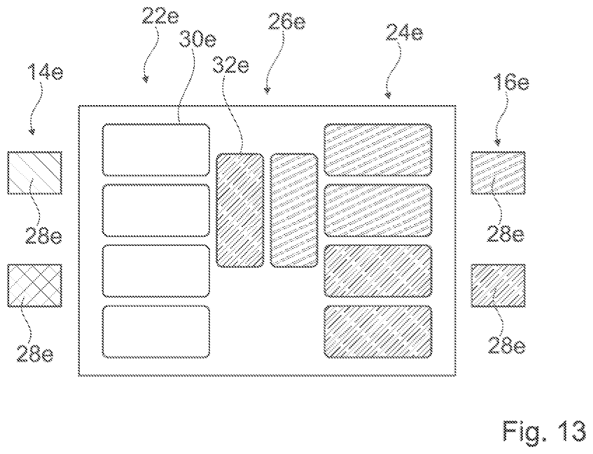

FIG. 13 shows a further selection of allocations that can be performed by means of the switching arrangement,

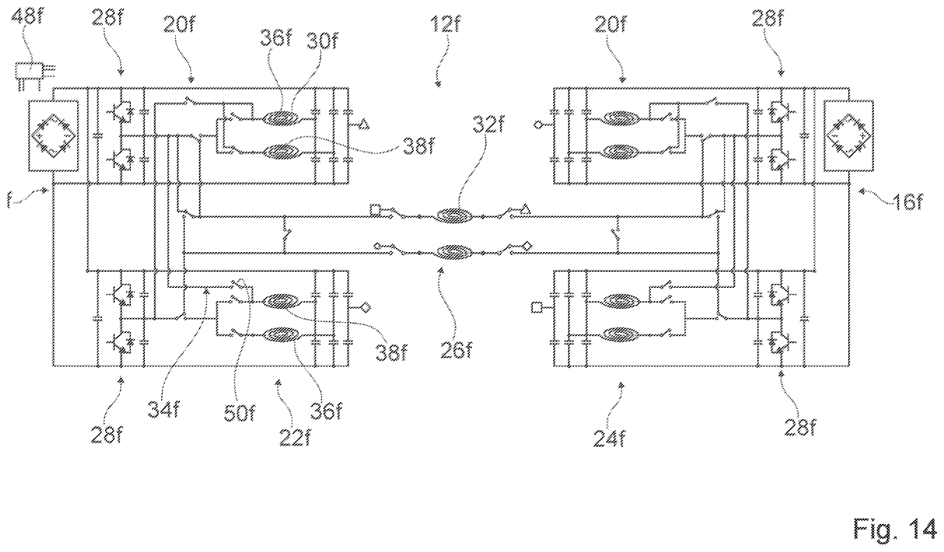

FIG. 14 shows a further cooktop apparatus of a further exemplary embodiment having a switching arrangement in a circuit diagram,

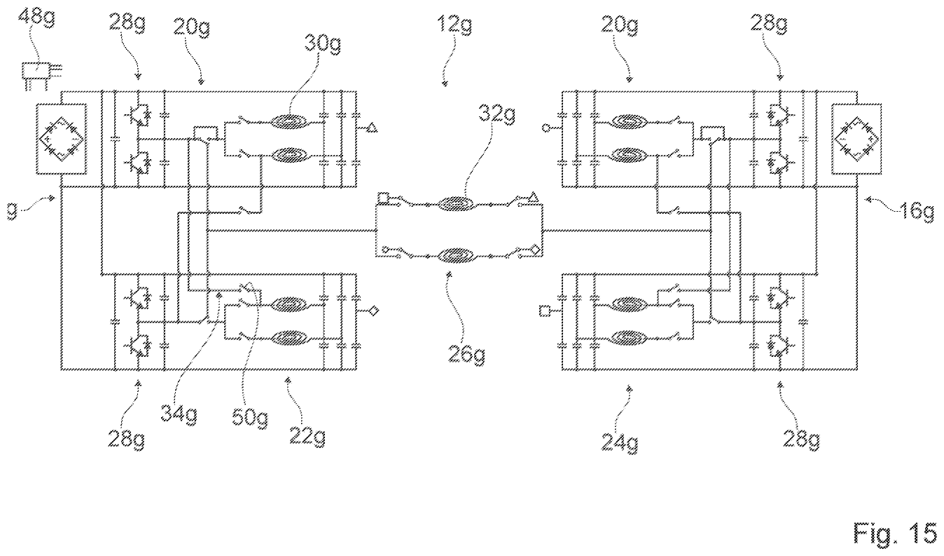

FIG. 15 shows a further cooktop apparatus of a further exemplary embodiment having a switching arrangement in a circuit diagram,

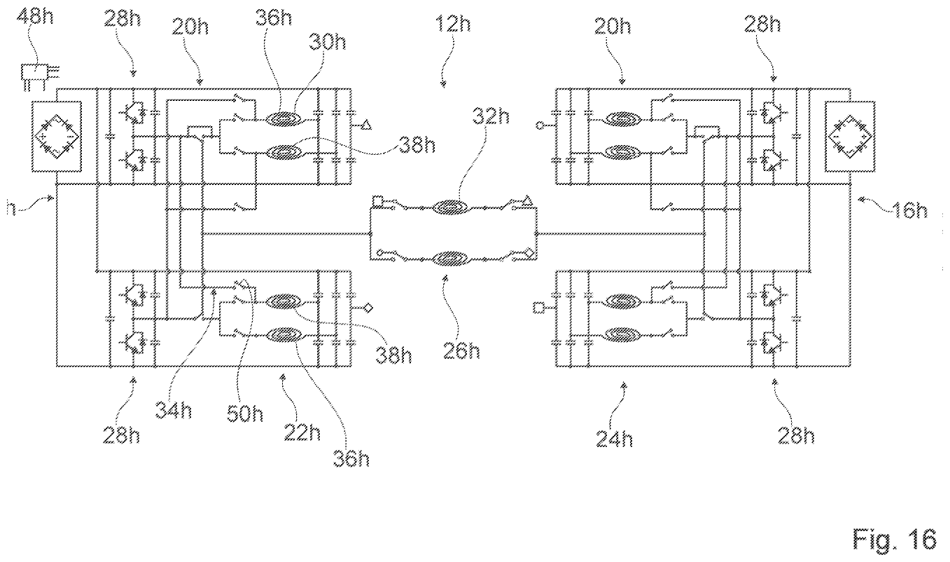

FIG. 16 shows a further cooktop apparatus of a further exemplary embodiment having a switching arrangement in a circuit diagram,

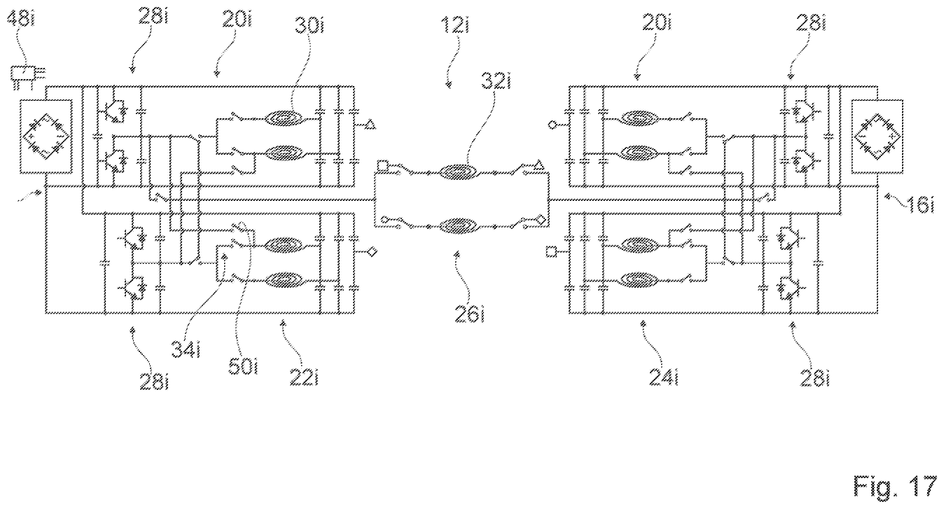

FIG. 17 shows a further cooktop apparatus of a further exemplary embodiment having a switching arrangement in a circuit diagram and

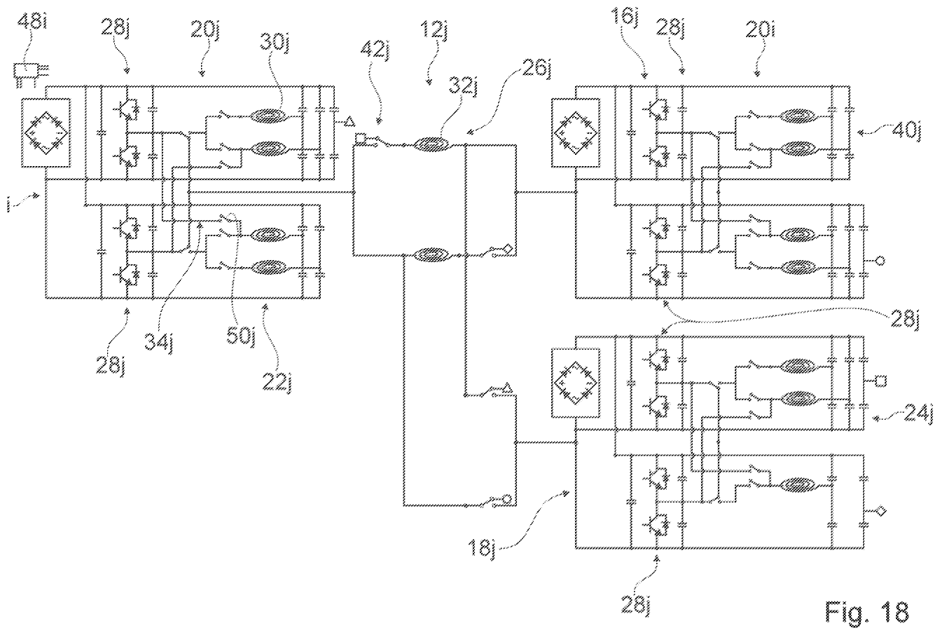

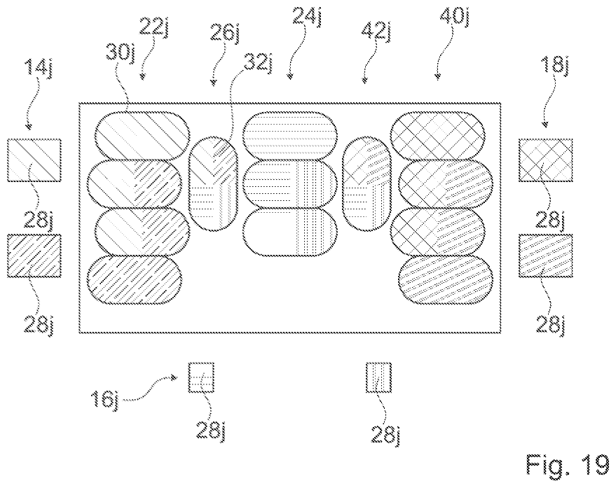

FIG. 18 shows a further selection of allocations that can be performed by means of the switching arrangement.

Only one of the objects present multiple times in the figures is provided with a reference character in each case.

FIG. 1 illustrates a cooktop 10a that is designed in the illustrated example as an induction cooktop. The cooktop 10a has a cooktop apparatus 12a. The cooktop apparatus 12a is embodied by way of example as an induction cooktop apparatus. The cooktop apparatus 12a that is illustrated in FIGS. 1 to 3 is in an exemplary operating state.

The cooktop apparatus 12a has a set of first heating units 22a. The set of first heating units 22a in the illustrated example has a number of four first heating units 30a (cf. also FIG. 2).

Moreover, the cooktop apparatus 12a has a set of second heating units 24a. The set of second heating units 24a in the illustrated example has a number of four second heating units 30a.

Moreover, the cooktop apparatus 12a has a set of third heating units 26a. The set of third heating units 26a in the illustrated example has a number of two third heating units 32a.

The third heating units 32a of the set of third heating units 26a are arranged spatially between the first heating units 30a of the set of first heating units 22a and the second heating units 30a of the set of second heating units 24a.

The third heating units 32a of the set of third heating units 26a have an at least essentially elongated geometry.

The third heating units 32a of the set of third heating units 26a are arranged in respect of their main extent 44a parallel to a depth direction 46a of the cooktop 10a.

And namely the third heating units 32a of the set of third heating units 26a are arranged in respect of their main extent 44a at least essentially at a right angle with respect to the first heating units 30a of the set of first heating units 22a.

The third heating units 32a of the set of third heating units 26a are arranged adjoining a plurality of first heating units 30a of the set of first heating units 22a and adjoining a plurality of second heating units 30a of the set of second heating units 24a.

In the illustrated example, a third heating unit 32a of the set of third heating units 26a is arranged adjoining three first heating units 30a of the set of first heating units 22a. Moreover, a third heating unit 32a of the set of third heating units 26a is arranged adjoining three second heating units 30a of the set of second heating units 24a.

Moreover, the cooktop apparatus 12a has a first heating frequency unit 14a (cf. in particular FIG. 2). The first heating frequency unit 14a in the illustrated example has two inverters 28a. Moreover, the cooktop apparatus 12a has a second heating frequency unit 16a. The second heating frequency unit 16a in the illustrated example likewise has two inverters 28a.

The cooktop apparatus 12a has a plurality of resonance units 52a, wherein in the illustrated example a number of four resonance units 52a is illustrated. The resonance units 52a are electrically connected to all the heating units of the sets of heating units 22a, 24a, 26a. The electrical connections between the heating units of the set of third heating units 26a and the respective resonance units 52a are illustrated in a simplified manner for the sake of clarity. In particular, all the electrical connections between the heating units of the set of third heating units 26a and the respective resonance units 52a are indicated in each case by identical symbols.

Moreover, the cooktop apparatus 12a has a switching arrangement 20a. It is possible by means of the switching arrangement 20a to electrically allocate the set of first heating units 22a to the first heating frequency unit 14a. The electrical allocation is performed in each case by means of switch positions of the switching arrangement 20a. For example, it would moreover be conceivable that the allocation is performed intermittently, in particular in a multiplexing operation.

Moreover, by means of the switching arrangement 20a it is possible to electrically allocate the set of second heating units 24a to the second heating frequency unit 16a.

Furthermore, by means of the switching arrangement 20a it is possible to electrically allocate the set of third heating units 26a to the first heating frequency unit 14a. Moreover, it is possible by means of the switching arrangement 20a to electrically allocate the set of third heating units 26a to the second heating frequency unit 16a.

The set of third heating units 26a can be allocated by means of the switching arrangement 20a to at least two of the heating frequency units 14a, 16a. The set of third heating units 26a can be electrically allocated by means of the switching arrangement 20a to the first heating frequency unit 14a and simultaneously to the second heating frequency unit 16a.

Moreover, the set of third heating units 26a can be allocated by means of the switching arrangement 20a to at least two inverters 28a of one of the heating frequency units 14a, 16a.

The two third heating units 32a of the set of third heating units 26a can be allocated by means of the switching arrangement 20a simultaneously to different heating frequency units 14a, 16a.

Moreover, all the sets of heating units 22a, 24a, 26a can be allocated by means of the switching arrangement 20a to different inverters 28a of the heating frequency units 14a, 16a.

In the illustrated operating state, the set of third heating units 26a and namely the two third heating units 32a of the set of third heating units 26a is allocated by means of the switching arrangement to the first heating frequency unit 14a.

The cooktop apparatus 12a moreover has a control unit 48a that is illustrated schematically in FIG. 2. The control unit 48a is provided so as to control the switching arrangement 20a as a function of a cookware configuration. And namely the control unit 48a controls the switching arrangement 20a as a function of the cookware configuration in respect of an allocation of sets of heating units 22a, 24a, 26a to heating frequency units 14a, 16a. In particular, the control unit 48a controls the switching arrangement 20a as a function of the cookware configuration in respect of an allocation of heating units 30a to inverters 28a.

FIG. 3 illustrates with the aid of different shadings a selection of allocations, which can be performed by means of the switching arrangement 20a, in particular as a function of the cookware configuration, of the heating units 30a, 32a of the sets of heating units 22a, 24a, 26a to the inverters 28a of the heating frequency units 14a, 16a.

FIG. 4 illustrates a flow diagram of a method 100a for operating the cooktop apparatus 12a. The method 100a has in particular a method step 102a and a further method step 104a.

In the method step 102a, the cooktop apparatus 12a is provided with the first heating frequency unit 14a, with the second heating frequency unit 16a, with the set of first heating units 22a, with the set of second heating units 24a and with the third heating units 26a.

In the method step 104a, the set of first heating units 22a is electrically allocated by means of the switching arrangement 20a to the first heating frequency unit 14a. Moreover, in the method step 104a the set of second heating units 24a is electrically allocated by means of the switching arrangement 20a to the second heating frequency unit 16a. Moreover, in the method step 104a the set of third heating units 26a is electrically allocated to any one heating frequency unit of the heating frequency units 14a, 16a.

In FIGS. 5 to 18, eight further exemplary embodiments of the invention are illustrated. The following descriptions are essentially restricted to the differences between the exemplary embodiments, wherein with regard to structural parts, features and functions which remain the same, reference can be made to the description of the other exemplary embodiments, in particular FIGS. 1 to 5. In order to differentiate the exemplary embodiments, the letter a is replaced in the reference characters of the exemplary embodiment of FIGS. 1 to 5 by the letters b to i in the reference characters of the exemplary embodiments of FIGS. 5 to 18. In relation to components that are referred to identically, in particular in reference to components having identical reference characters, it is possible in principle to refer to the drawings and/or the description of the other exemplary embodiments, in particular of FIGS. 1 to 5.

FIG. 5 illustrates a further exemplary embodiment of a cooktop apparatus 12b in a circuit diagram.

The cooktop apparatus 12b has a set of first heating units 22b. The set of first heating units 22b in the illustrated example has a number of four first heating units 30b.

Moreover, the cooktop apparatus 12b has a set of second heating units 24b. The set of second heating units 24b in the illustrated example has a number of four second heating units 30b.

Moreover, the cooktop apparatus 12b has a set of third heating units 26b. The set of third heating units 26b in the illustrated example has a number of two third heating units 32b.

Moreover, the cooktop apparatus 12b has a first heating frequency unit 14b. The first heating frequency unit 14b in the illustrated example has two inverters 28b. Moreover, the cooktop apparatus 12b has a second heating frequency unit 16b. The second heating frequency unit 16b in the illustrated example likewise has two inverters 28b.

Moreover, the cooktop apparatus 12b has a switching arrangement 20b. In comparison with the previous exemplary embodiment, the switching arrangement 20b of the present exemplary embodiment moreover has a parallel switching unit 34b. The parallel switching unit 34b has a plurality of parallel switching elements 50b.

It is possible by means of the switching arrangement 20b, and namely using the parallel switching unit 34b of the switching arrangement 20b, to connect at least two inverters 28b of one of the heating frequency units 14b in parallel.

The heating units 30b of the set of first heating units 22b can be allocated by means of the switching arrangement 20b simultaneously to multiple inverters 28b of one of the heating frequency units 14b, 16b.

And namely the heating units 30b of the set of first heating units 22b can be allocated by means of the switching arrangement 20b simultaneously to the inverters 28b that are connected in parallel by means of the switching arrangement 20b.

The heating units 30b of the set of second heating units 24b can likewise be allocated by means of the switching arrangement 20b simultaneously to multiple inverters 28b of one of the heating frequency units 14b, 16b.

And namely the heating units 30b of the set of second heating units 24b can likewise be allocated by means of the switching arrangement 20b simultaneously to the inverters 28b that are connected in parallel by means of the switching arrangement 20b.

FIG. 6 illustrates with the aid of different shadings a selection of allocations, which can be performed by means of the switching arrangement 20b, in particular as a function of a cookware configuration, of the heating units 30b, 32b of the sets of heating units 22b, 24b, 26b to the inverters 28b of the heating frequency units 14b, 16b.

FIGS. 7a to 7d illustrate a selection of possible operating states, and namely in particular based on different cookware configurations. The allocations, which are illustrated by different shadings, of the heating units 30b, 32b of the sets of heating units 22b, 24b, 26b to the inverters 28b of the heating frequency units 14b, 16b are performed by means of respective switch positions of the switching arrangement 20b, and in particular based on an actuation by the control unit 48b. It is known to the person skilled in the art that in addition to the illustrated selection of cookware configurations, further cookware configurations are possible by means of the switching arrangement 20b.

FIG. 8 illustrates a further exemplary embodiment of a cooktop apparatus 12c in a circuit diagram.

The cooktop apparatus 12c has a set of first heating units 22c. The set of first heating units 22c in the illustrated example has two outer heating units 36c. Moreover, the set of first heating units 22c has two inner heating units 38c that are arranged within the outer heating units 36c.

Moreover, the cooktop apparatus 12c has a set of second heating units 24c. The set of second heating units 24c in the illustrated example likewise has two outer heating units 36c. Moreover, the set of second heating units 24c likewise has two inner heating units 38c that are arranged within the outer heating units 36c.

The cooktop apparatus 12c moreover has a first heating frequency unit 14c. The first heating frequency unit 14c in the illustrated example has two inverters 28c. Moreover, the cooktop apparatus 12c has a second heating frequency unit 16c. The second heating frequency unit 16c in the illustrated example likewise has two inverters 28c.

Moreover, the cooktop apparatus 12c has a switching arrangement 20c. In comparison with the previous exemplary embodiment, by means of the switching arrangement 20c of the present exemplary embodiment moreover the inner heating units 38c and the outer heating units 36c can be allocated by means of the switching arrangement 20c simultaneously to different inverters 28c of one of the heating frequency units 14c, 16c (cf. in addition FIG. 9).

FIG. 9 illustrates with the aid of different shadings a further selection of allocations, which can be performed by means of the switching arrangement 20c, in particular as a function of a cookware configuration, of the heating units 30c, 32c of the sets of heating units 22c, 24c, 26c to the inverters 28c of the heating frequency units 14c, 16c.

FIG. 10 illustrates a further exemplary embodiment of a cooktop apparatus 12d in a circuit diagram.

The cooktop apparatus 12d has a set of first heating units 22d. The set of first heating units 22d in the illustrated example has a number of four first heating units 30d.

Moreover, the cooktop apparatus 12d has a set of second heating units 24d. The set of second heating units 24d in the illustrated example has a number of four second heating units 30d.

Moreover, the cooktop apparatus 12d has a set of third heating units 26d. The set of third heating units 26d in the illustrated example has a number of two third heating units 32d.

The cooktop apparatus 12d moreover has a first heating frequency unit 14d. The first heating frequency unit 14d in the illustrated example has two inverters 28d. Moreover, the cooktop apparatus 12d has a second heating frequency unit 16d. The second heating frequency unit 16d in the illustrated example likewise has two inverters 28d.

Moreover, the cooktop apparatus 12d has a switching arrangement 20d. In comparison with the previous exemplary embodiments, by means of the switching arrangement 20d of the present exemplary embodiment moreover the set of third heating units 26d can be allocated with the set of first heating units 22d and/or with the set of second heating units 24d to a common inverter 28d of one of the heating frequency units 14d.

Moreover, by means of the switching arrangement 20d the set of third heating units 26d can be allocated with the set of first heating units 22d to a common inverter 28d of one of the heating frequency units 14d, 16d and can be allocated simultaneously by means of the switching arrangement 20d with the set of second heating units 24d to a common inverter 28d of one of the heating frequency units 14d, 16d.

FIGS. 11a to 11j illustrate a selection of possible operating states and namely in particular based on different cookware configurations. For the sake of clarity, the illustrations are cut off centrally so that the illustration is provided by way of example in each case with reference to half of a cooktop 10d.

The allocations, which are illustrated by different shadings, of the heating units 30d, 32d of the sets of heating units 22d, 24d, 26d to the inverters 28d of the heating frequency units 14d, 16d are provided by respective switch positions of the switching arrangement 20d, and in particular based on an actuation by the control unit 48d. It is known to the person skilled in the art that in addition to the illustrated selection of cookware configurations, further cookware configurations are possible by means of the switching arrangement 20d.

FIG. 12 illustrates a further exemplary embodiment of a cooktop apparatus 12e in a circuit diagram.

The cooktop apparatus 12e has a set of first heating units 22e. The set of first heating units 22e in the illustrated example has a number of four first heating units 30e.

Moreover, the cooktop apparatus 12e has a set of second heating units 24e. The set of second heating units 24e in the illustrated example has a number of four second heating units 30e.

Moreover, the cooktop apparatus 12e has a set of third heating units 26e. The set of third heating units 26e in the illustrated example has a number of two third heating units 32e.

The cooktop apparatus 12e moreover has a first heating frequency unit 14e. The first heating frequency unit 14e in the illustrated example has two inverters 28e. Moreover, the cooktop apparatus 12e has a second heating frequency unit 16e. The second heating frequency unit 16e in the illustrated example likewise has two inverters 28e.

Moreover, the cooktop apparatus 12e has a switching arrangement 20e. In comparison with the previous exemplary embodiments, by means of the switching arrangement 20e of the present exemplary embodiment moreover in each case at least two heating units 30e, 32e of all the sets of heating units 22e, 24e 26e can be allocated in each case to different inverters 28e of one of the heating frequency units 14e, 16e (cf. also FIG. 13).

FIG. 14 illustrates a further exemplary embodiment of a cooktop apparatus 12f in a circuit diagram.

The exemplary embodiment of the cooktop apparatus 12f that is illustrated in FIG. 14 and that comprises a switching arrangement 20f adds the functionality to the cooktop apparatus 12f of the present exemplary embodiment in comparison with the previous exemplary embodiment that by means of the switching arrangement 20f moreover at least two inner heating units 38f of a set of heating units 22f, 24f and at least two outer heating units 36f of a set of heating units 22f, 24f can be allocated by means of the switching arrangement 20f simultaneously to different inverters 28f of a heating frequency unit 14f, 16f of the cooktop apparatus 12f.

FIG. 15 illustrates a further exemplary embodiment of a cooktop apparatus 12g in a circuit diagram.

The cooktop apparatus 12g has a set of first heating units 22g. The set of first heating units 22g in the illustrated example has a number of four first heating units 30g.

Moreover, the cooktop apparatus 12g has a set of second heating units 24g. The set of second heating units 24g in the illustrated example has a number of four second heating units 30g.

Moreover, the cooktop apparatus 12g has a set of third heating units 26g. The set of third heating units 26g in the illustrated example has a number of two third heating units 32g.

Moreover, the cooktop apparatus 12g has a first heating frequency unit 14g. The first heating frequency unit 14g in the illustrated example has two inverters 28g. Moreover, the cooktop apparatus 12g has a second heating frequency unit 16g.

The second heating frequency unit 16g in the illustrated example likewise has two inverters 28g.

Moreover, the cooktop apparatus 12g has a switching arrangement 20g.

The switching arrangement 20g of the present exemplary embodiment in comparison with the previous exemplary embodiments has an additional short-circuit contact that is arranged between one of the inverters 28g of the first heating frequency unit 14g and one of the heating units 30g of the set of first heating units 22g.

In comparison with the previous exemplary embodiments of the cooktop apparatus 12g, with the switching arrangement 20g of the present exemplary embodiment in each case only three upper heating units 30g of the set of first heating units 22g and/or of the set of second heating units 24g can be allocated together with at least one third heating unit 32g of the set of third heating units 26g to an inverter 28g of one of the heating frequency units 14g, 16g.

FIG. 16 illustrates a further exemplary embodiment of a cooktop apparatus 12h in a circuit diagram.

The exemplary embodiment, which is illustrated in FIG. 16, of the cooktop apparatus 12h that has a switching arrangement 20h adds the functionality to the cooktop apparatus 12h of the present exemplary embodiment in comparison with the previous exemplary embodiment that by means of the switching arrangement 20h moreover at least two inner heating units 36h of a set of heating units 22h, 24h and at least two outer heating units 36h of a set of heating units 22h, 24h can be allocated by means of the switching arrangement 20h simultaneously to different inverters 28h of a heating frequency unit 14h, 16h of the cooktop apparatus 12h.

FIG. 16 illustrates a further exemplary embodiment of a cooktop apparatus 12i in a simplified circuit diagram.

The exemplary embodiment, which is illustrated in FIG. 16, of the cooktop apparatus 12i that has a switching arrangement 20i provides by means of the switching arrangement 20i in particular a modification of the switching arrangement 20b of the exemplary embodiment of the cooktop apparatus 12b and the switching arrangement 20d of the exemplary embodiment of the cooktop apparatus 12d.

The cooktop apparatus 12i has a set of first heating units 22i. Moreover, the cooktop apparatus 12i has a set of second heating units 24i. Furthermore, the cooktop apparatus 12i has a set of third heating units 26i. The cooktop apparatus 12i moreover has a first heating frequency unit 14i and a second heating frequency unit 16i. The first heating frequency unit 14i and the second heating frequency unit 16i in the illustrated example has in each case two inverters 28i.

In comparison with the switching arrangement 20b of the exemplary embodiment of the cooktop apparatus 12b, the switching arrangement 20i of the present exemplary embodiment of the cooktop apparatus 12i has two additional switching elements, wherein one of the additional switching elements is arranged electrically between one of the inverters 28i of the first heating frequency unit 14i and the set of third heating units 26i. A further one of the additional switching elements of the switching arrangement 20i is arranged electrically between one of the inverters 28i of the second heating frequency unit 16i and the set of third heating units 26i.

FIG. 18 illustrates a further exemplary embodiment of a cooktop apparatus 12j in a circuit diagram.

The cooktop apparatus 12j has a set of first heating units 22j. The set of first heating units 22j in the illustrated example has a number of four first heating units 30j.

Moreover, the cooktop apparatus 12j has a set of second heating units 24j. The set of second heating units 24j in the illustrated example has a number of three second heating units 30j.

Moreover, the cooktop apparatus 12j has a set of third heating units 26j. The set of third heating units 26j in the illustrated example has a third heating unit 32j.

The third heating unit 32j of the set of third heating units 26j is arranged spatially between the first heating units 30j of the set of first heating units 22j and the second heating units 30j of the set of second heating units 24j.

Moreover, the cooktop apparatus 12j has a set of fourth heating units 40j. The set of fourth heating units 40j in the illustrated example has a number of four fourth heating units 30j.

Moreover, the cooktop apparatus 12j has a set of fifth heating units 42j. The set of fifth heating units 42j in the illustrated example has a fifth heating unit 30j.

The fifth heating unit 30j of the set of fifth heating units 42j is arranged spatially between the second heating units 30j of the set of second heating units 24j and the fourth heating units 30j of the set of fourth heating units 40j.

Moreover, the cooktop apparatus 12j has a first heating frequency unit 14j. The first heating frequency unit 14j in the illustrated example has two inverters 28j. Moreover, the cooktop apparatus 12j has a second heating frequency unit 16j. The second heating frequency unit 16j in the illustrated example likewise has two inverters 28j. The cooktop apparatus 12j moreover has a third heating frequency unit 18j. The third heating frequency unit 18j in the illustrated example has likewise two inverters 28j.

Moreover, the cooktop apparatus 12j has a switching arrangement 20j.

It is possible by means of the switching arrangement 20j to electrically allocate the set of fourth heating units 18j to the third heating frequency unit. The set of fifth heating units 42j can be electrically allocated by means of the switching arrangement 20j to the second heating frequency unit 16j and/or to the third heating frequency unit 18j.

In particular, the features that are described above for the set of first heating units, the set of second heating units and the set of third heating units apply in a similar manner for the set of fourth heating units 40j and the set of fifth heating units 42j. FIG. 18 illustrates with the aid of different shadings a further selection of allocations, which can be performed by means of the switching arrangement 20j, in particular as a function of a cooking configuration, of the heating units 30j, 32j of the sets of heating units 22j, 24j, 26j, 40j, 42j to the inverters 28j of the heating frequency units 14j, 16j, 18j.

In particular, modifications of all the exemplary embodiments are conceivable, which alternatively or in addition have individual or all functionalities of the in each case other exemplary embodiments, by means of alternative or additional implementations of the respective switching arrangements 20a-j of the in each case other exemplary embodiments. In this regard, it is conceivable that modifications of the exemplary embodiments alternatively or in addition have a selection of, or all, switching elements of the respective switching arrangements 20a-j of the in each case other exemplary embodiments.

### REFERENCE CHARACTERS

10 Cooktop
12 Cooktop apparatus
14 First heating frequency unit
16 Second heating frequency unit
18 Third heating frequency unit
20 Switching arrangement
22 Set of first heating units
24 Set of second heating units
26 Set of third heating units
28 Inverter
30 Heating unit
32 Third heating unit
34 Parallel switching unit
36 Outer heating unit
38 Inner heating unit
40 Set of fourth heating units
42 Set of fifth heating units
44 Main extent
46 Depth direction
48 Control unit
50 Parallel switching element
52 Resonance unit
100 Method
102 Method step
104 Further method step

1-15. (canceled)

16. A cooktop apparatus, comprising:
a first heating frequency unit;
a second heating frequency unit;
a set of first heating units;
a set of second heating units;
a set of third heating units; and
a switching arrangement configured to electrically allocate the set of first heating units to the first heating frequency unit, to electrically allocate the set of second heating units to the second heating frequency unit, and to electrically allocate the set of third heating units to at least one of the first and second heating frequency units.

17. The cooktop apparatus of claim 16, constructed in a form of an induction cooktop apparatus.

18. The cooktop apparatus of claim 16, wherein the switching arrangement is configured to electrically allocate the set of third heating units to the first heating frequency unit and to the second heating frequency unit.

19. The cooktop apparatus of claim 16, wherein the switching arrangement is configured to electrically allocate the set of third heating units to at least two inverters of one of the first and second heating frequency units.

20. The cooktop apparatus of claim 16, wherein the switching arrangement is configured to electrically allocate the set of third heating units to the first and second heating frequency units.

21. The cooktop apparatus of claim 16, wherein the set of third heating units comprises at least two third heating units, said switching arrangement configured to electrically allocate the at least two third heating units simultaneously to different ones of the first and second heating frequency units.

22. The cooktop apparatus of claim 16, wherein the switching arrangement is configured to electrically allocate the set of third heating units with at least one of the set of first heating units and the set of second heating units to a common inverter of one of the first and second heating frequency units.

23. The cooktop apparatus of claim 16, wherein the switching arrangement is configured to electrically allocate the set of third heating units with the set of first heating units to a common inverter of one of the first and second heating frequency units and simultaneously to electrically allocate the set of second heating units to a common inverter of one of the first and second heating frequency units.

24. The cooktop apparatus of claim 16, wherein the switching arrangement includes a parallel switching unit configured to connect at least two inverters of one of the first and second heating frequency units in parallel, at least one of the set of first heating units and the set of second heating units including a plurality of heating units, said switching arrangement configured to electrically allocate the plurality of heating units simultaneously to multiple inverters of one of the first and second heating frequency units

25. The cooktop apparatus of claim 16, wherein the switching arrangement is configured to electrically allocate the sets of first, second and third heating units to different inverters of the first and second heating frequency units.

26. The cooktop apparatus of claim 16, wherein the sets of first, second and third heating units comprise at least two heating units, said switching arrangement configured to allocate the at least two heating units to different inverters of one of the first and second heating frequency units.

27. The cooktop apparatus of claim 16, wherein at least one of the set of first heating units and the set of second heating units includes at least two outer heating units and at least two inner heating units that are arranged within the outer heating units, said switching arrangement configured to allocate the at least two inner heating units and the at least two outer heating units simultaneously to different inverters of one of the first and second heating frequency units.

28. The cooktop apparatus of claim 16, further comprising a third heating frequency unit, a set of fourth heating units, and a set of fifth heating units, said switching arrangement configured to electrically allocate the set of fourth heating units to the third heating frequency unit and to electrically allocate the set of fifth heating units to at least one of the second heating frequency unit and the third heating frequency unit.

29. The cooktop apparatus of claim 16, wherein the set of third heating units is arranged spatially between the set of first heating units and the set of second heating units.

30. A cooktop, comprising a cooktop apparatus, said cooktop apparatus comprising a first heating frequency unit, a second heating frequency unit, a set of first heating units, a set of second heating units, a set of third heating units, and a switching arrangement configured to electrically allocate the set of first heating units to the first heating frequency unit, to electrically allocate the set of second heating units to the second heating frequency unit, and to electrically allocate the set of third heating units to at least one of the first and second heating frequency units.

31. The cooktop of claim 30, constructed in a form of an induction cooktop.

32. A method for operating a cooktop apparatus comprising a first heating frequency unit and a second heating frequency unit, the method comprising:
electrically allocating a set of first heating units of the cooktop apparatus to the first heating frequency unit;
electrically allocating a set of second heating units of the cooktop apparatus to the second heating frequency unit; and
electrically allocating a set of third heating units to one of the first and second heating frequency units.

33. The method of claim 32 for operating an induction cooktop apparatus.
